(19) United States
(12) Patent Application Publication
(10) Pub. No.: US 2011/0208951 A1
(43) Pub. Date: Aug. 25, 2011

(54) INSTRUCTION PROCESSOR AND METHOD THEREFOR

(75) Inventor: Scott A. Hilker, Campbell, CA (US)

(73) Assignee: ADVANCED MICRO DEVICES, INC., Sunnyvale, CA (US)

(21) Appl. No.: 12/709,945

(22) Filed: Feb. 22, 2010

(51) Int. Cl. G06F 9/312; G06F 9/302

(52) U.S. Cl. 712/221; 712/225; 712/E09.017; 712/E09.033

(57) ABSTRACT

A method of executing a program instruction is disclosed. An instruction operand stored at a register of a register file is accessed by an execution unit using multiple access requests. A first portion of the execution unit provides a first access request to a first access port of the register file to access a first portion of the instruction operand. A second portion of the execution unit provides a second access request to a second access port of the register file to access a second portion of the instruction operand. The register file can be configured into physically separate portions.

### BACKGROUND

1. Field of the Disclosure

The present disclosure relates generally to data processing, and more particularly to data processors that execute instructions.

2. Description of the Related Art

A processing core can include multiple data processors that execute program instructions by performing various arithmetic operations, such as addition, multiplication, multiply-accumulate, and the like, which may include various numerical formats such as integer and floating point formats. Furthermore, the program instructions can include single-instruction single-data (SISD) instructions, and single-instruction multiple-data (SIMD) instructions. A SIMD instruction is program instruction that specifies that an arithmetic operation be performed independently a plurality of times, once for each of a plurality of operational operands retrieved as part of a single instruction operand of the SIMD instruction. A SISD instruction specifies that the arithmetic operation be performed a single time for an operational operand that corresponds to the instruction operand of the SISD instruction. The computational performance of a data processing device can be determined by the speed at which the coprocessor device can execute program instructions. Accordingly, it is desirable to increase the speed at which the processor device can execute program instructions, such as SIMD instructions, SISD instructions, and the like.

### BRIEF DESCRIPTION OF THE DRAWINGS

The present disclosure may be better understood, and its numerous features and advantages made apparent to those skilled in the art by referencing the accompanying drawings.

FIG. 1 is a block diagram illustrating a data processing device 100 in accordance with a specific embodiment of the present disclosure.

FIG. 2 is a block diagram illustrating a coprocessor in accordance with a specific embodiment of the present disclosure.

FIG. 3 is a flow diagram illustrating a method for executing a program instruction at an execution unit, such as an execution unit of FIG. 2, in accordance with a specific embodiment of the present disclosure.

FIG. 4 includes a block diagram illustrating data flow in accordance with a specific embodiment of the present disclosure.

FIG. 5 is a flow diagram illustrating a method for executing another program instruction at an execution unit, such as an execution unit of FIG. 2 in accordance with a specific embodiment of the present disclosure.

FIG. 6 includes a block diagram illustrating the method of FIG. 5 in accordance with a specific embodiment of the present disclosure.

FIG. 7 is a block diagram illustrating a computer readable memory being used to configure fabrication equipment used to manufacture a device in accordance with a specific embodiment of the present disclosure.

### DETAILED DESCRIPTION

A specific embodiment of a data processing device is disclosed that includes a data processor that includes one or more execution units and a register file. Each execution unit is configured into physically separate portions that reside on different sides of the register file. The register file includes a plurality of registers and a plurality of access ports, and can be configured in to physically separate portions that reside on either side of a data transfer module.

A first set of access ports of the register file is connected to a first portion of each execution unit a second set of access ports of the register file is connected to the second portion of each execution unit, wherein the first and second portions of an execution unit are physically separate from each other. The register file's first set of access ports can access only a first portion of each register of the register file, the register file's second set of access ports can access only a second portion of each register of the register file. Therefore, during operation, two access requests, one from each portion of an execution unit, are used to access each instruction operand at a register of the register file in response to a program instruction being executed by the execution unit. By partitioning the execution units of a data processor into two physically separate portions that reside on either side of a register file, and configuring each execution unit portion to only access a portion of the information at a register, the total capacitance associated with the drivers and wire interconnects needed to exchange information between the execution units and the register file is reduced, thereby facilitating a performance improvement with respect to the total power consumed by a data processor and the attainable speed of the data processor.

Splitting the register file and execution units into physically separate portions allows each of the physically separated portions of an execution unit to execute a portion of the operations performed by a specific SIMD instruction entirely independently of the other portion of the execution unit. For example, an execution unit that executes a SIMD instruction having a 128-bit instruction operand representing two 64-bit operational operands can implement a 64-bit arithmetic operation at one portion of the execution unit using one of the two 64-bit operational operands, and implement the same 64-bit arithmetic operation at the other portion of the execution unit using the other of the two 64-bit operational operands. Since the arithmetic operations are independent operations, neither of the two 64-bit arithmetic operations needs a result from the other operation, and a higher frequency of operation can be achieved for SIMD instructions by using physically separate execution unit portions and register file portions.

A data processor partitioned in the manner described above can also be configured to execute a single-instruction single-data (SISD) instruction that performs a single operation on the full data-width of the instruction operand, e.g., the operational operand of a SISD instruction can be the same size as the instruction operand, by facilitating the transfer of an intermediate result from one portion of a register to the other portion of register. This transfer can be accomplished by a transfer module, such as a cross-bar switch, that is connected between the first set of access ports and the second set of access ports of the register file. Various implementations of the present disclosure will be better understood with reference to the following figures.

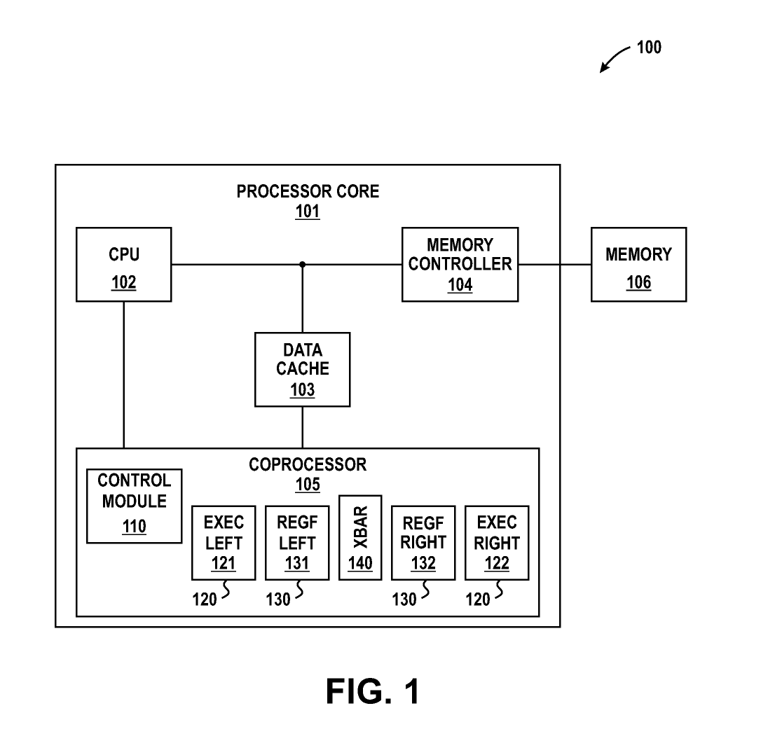

FIG. 1 is a block diagram illustrating a data processing device 100 in accordance with a specific embodiment of the present disclosure. Data processing device 100 includes a processor core 101 and a memory device 106. Processor core 101 can be formed as an integrated circuit device that includes a central processing unit (CPU) 102, a data cache memory 103, a memory controller 104, and a coprocessor 105. Coprocessor 105 is a data processor that can implement various arithmetic operations, and includes a control module 110, an execution unit 120 having a left portion 121 and a right portion 122, a register file 130 having a left portion, register file portion 131, and a right portion, register file portion 132, and a cross-bar switch 140. It will be appreciated that while coprocessor 105 is illustrated as being separate from CPU 102, the features of coprocessor 105 can also be implemented as part of one or more data processors within CPU 102. Additionally, coprocessor 105 can be implemented as a device separate from processor core 101 such as, for example, as a discrete device.

Coprocessor 105 is configured to execute one or more program instructions, such as general purpose arithmetic instructions associated with a specific program. For example, execution unit 120 can execute an arithmetic program instruction wherein a portion of the program instruction is executed at execution unit portion 121 of execution unit 120 and another portion of the arithmetic instruction is executed at execution unit portion 122 of execution unit 120. Furthermore, coprocessor 105 is configured to store data information to be manipulated by the arithmetic instruction, e.g., an instruction operand of the arithmetic instruction, as two portions, one portion stored at register file portion 131 and the other portion stored at register file portion 132.

During operation of data processing device 100, CPU 102 can access program instructions stored at memory device 106 via memory controller 104. A program instruction can be associated with different classes of instructions. A specific class of program instructions can be limited to execution at a specific data processor, such as coprocessor 105, or can be executed at more than one data processor. For example, some SIMD instructions may be limited to being executed at coprocessor 105, while some SISD instruction cannot be executed at coprocessor 105. In addition, some SIMD and SISD instruction may be executed at an execution unit included at CPU 102 (not shown), or at coprocessor 105. It will be appreciated that a program instruction can exhibit characteristics of different classes of instructions. For example, an program instruction can exhibit characteristics of both a SIMD instruction and a SISD instruction, such as an instruction that multiplies a plurality of operational operands independent of each other storing the independent results in a common register of register file 130, similar to a SIMD instruction, and then adds the plurality of independent results to form a single accumulated result that is stored at a register of register file 130, similar to a SISD instruction.

SIMD instructions are particularly well suited for implementing graphics and signal processing related algorithms. As discussed previously, a SIMD instruction can designate that a specified arithmetic operation be performed a plurality of times on a corresponding plurality of operational operands that make up a single instruction operand of the SIMD instruction. For example, an instruction operand of the SIMD instruction stored at a register of register file 130 includes a first portion of the instruction operand stored at a first portion of the register, e.g., a portion of the register at register file portion 131, and a second portion of the instruction operand stored at a second portion of the register, e.g., a portion of the register at register file portion 132. Therefore, a SIMD instruction that performs eight add operations on 16-bit operational operands can be executed by coprocessor 105 accessing two 128-bit instruction operands stored at two different registers of register file 130. Whereby, each of the two 128-bit instruction operands would include eight addends, e.g., eight operational operands, that are operated upon independently to provide eight individual results.

Another type of arithmetic instruction, as discussed previously, includes SISD instructions. A SISD instruction designates that a specified arithmetic operation be performed a single time on a single operational operand, e.g., there is one operational operand per instruction operand. With respect to coprocessor 105, a portion of an operational operand is stored at a register portion at register file portion 131 and another portion of the operational operand is stored at the corresponding register portion at register file portion 132. For example, a SISD instruction that adds two operational operands may be executed by coprocessor 105 to perform a single 128-bit addition operation on two 128-bit operational operands that correspond to two 128-bit instruction operands stored at different registers of register file 130 in order to provide a single 128-bit result, where each register stores data information representing a single operational operand. In an embodiment, each register at register file 130 can include 128 bits of information, wherein 64 bits of the data information is stored at a register portion at register file portion 131 and another 64 bits of the data information is stored at a corresponding register portion at register file portion 132.

Coprocessor 105 includes a control module 110 to manage operation of coprocessor 105, including the receipt of arithmetic program instructions at coprocessor 105, access of instruction operands associated with program instructions, and scheduling and control of the interaction between execution unit 120, register file 130, and cross-bar switch 140. In an embodiment, control module 110 includes a micro-sequencer device (not shown) operable to execute micro-code instructions stored at a micro-code memory device. The micro-sequencer device, in addition to other logic modules included at control module 110, can configure modules at coprocessor 105 to implement a sequential procedure to perform the operation specified by an arithmetic program instruction.

When executing a SIMD instruction, execution unit portion 121 and execution unit portion 122 operate substantially autonomously whereby each portion can independently perform one or more arithmetic operations independent of any data information from the other portion. For example, execution unit portion 121 and execution unit portion 122 can each include an access control module that provides access requests to its respective portion of the register file to access information, and each execution unit portion can perform individual arithmetic operations associated with a respective portion of a SIMD instruction. When executing a SISD instruction, execution unit portion 121 and execution unit portion 122 can together perform a single operation associated with a SISD program instruction, wherein cross-bar switch 140 is configured to transfer data information between execution unit portion 121 and execution unit portion 122 (using register file 130) to facilitate the execution of the SISD program instruction. Accordingly, execution unit portion 121 and execution unit portion 122 can together execute a single program instruction, wherein each instruction operand associated with the program instruction includes more bits of data information than can be processed by either execution unit portion 121 or execution unit portion 122 individually. It will be appreciated that coordination between the various portions of an execution unit to complete a SISD instruction can be controlled by the control module 110, which can coordinate a transfer of information based upon communications from one or more of execution unit portion 121 and execution unit portion 122, and which can coordinate a transfer of information based upon defined timing requirements of execution unit portion 121 and execution unit portion 122.

Data information can be stored at a register of register file 130 by control module 110. For example, control module 110 can store an instruction operand received from data cache memory 103 to a register at register file 130, whereby a first portion of the instruction operand is stored at a location of register file portion 131 corresponding to the register, and a second portion of the instruction operand stored at a location of register file portion 132 corresponding to the register. Each portion of execution unit 120 is associated with a corresponding register file portion in that it can access only one of the two register file portions directly. For example, execution unit portion 121 can directly access (store and retrieve) data information at register file portion 131, and execution unit portion 122 can directly access data information at register file portion 132. Data information can be stored at each portion of register file 130 by providing a store access request that includes an address identifying a register portion location, providing data information to be stored at the register portion, and asserting appropriate control signals, such as a write enable signal. Data information can be retrieved from each portion of register file 130 by providing a load access request that includes an address identifying the location of the register portion to be read, and asserting appropriate control signals, such as a read enable signal.

Each register file portion of register file 130 includes a plurality of access ports, each access port to receive a corresponding set of control signals, and each access port operable to provide access to a portion of each register of register file 130. For example, register file portion 131 can include the 64 most-significant bits of each one of a plurality of data registers at register file 130, while register file portion 132 can include the 64 least-significant bits of each one of the plurality of data registers. In addition, each of register file portion 131 and 132 can include a plurality of access ports. For example, they each can include ten read access ports to provide data information in response to a read access request and six write ports to receive and store data information in response to a write access request. In an embodiment, coprocessor 105 includes multiple execution units (not illustrated), in addition to execution unit 120, with each execution unit having two physically separate portions that reside close to a corresponding portion of the register file to access data information stored at register file portion 131 and register file portion 132 independently.

Cross bar switch 140 is configured to transfer data information between register portions at register file portions 131 and 132. For example, cross-bar switch 140 can retrieve data information stored at a portion of a register, e.g., register portion 132 using one access port of a set of access ports of register portion 132 to read the stored information, and store data information at another portion of the register, e.g., register portion 131 using one access port of a set of access ports at register portion 131 to store the information being transferred. Thus, cross-bar switch 140 can enable the sharing of data information between the physically separate portions of execution unit 120. For example, when execution unit portion 121 and execution unit portion 122 are together performing a SISD arithmetic operation, intermediate calculation results can be exchanged between each portion of execution unit 120 via cross-bar switch 140 by way of respective portions 131 and 132 of register file 130.

In one embodiment, cross-bar switch 140 is configured to perform a desired transfer of data information in response to one or more micro-sequencer device commands executed by control module 110. In another embodiment, cross-bar switch 140 can perform operations that manipulate data information that is being transferred between two register portions at register file 130, such as operations that format data or that shift blocks of data amongst the data ports, where a block of data is associated with a specific data unit, such as a bit, a nibble, a byte, and the like.

In an embodiment, register file portion 131, cross-bar switch 140, and register file portion 132 are positioned between execution unit portion 121 and execution unit portion 122. For example, the locations of register file portion 131, register file portion 132, execution unit portion 121, execution unit portion 122, and cross-bar switch 140 as illustrated in FIG. 1 can represent their layout locations with respect to each other, whereby a cross-section line (not shown) can be drawn from a location at the left portion 121 of execution unit 120 and a location at the right portion 122 of execution unit 120 that intersects register file 130 at either or both of portions 131 and 132. Accordingly, execution unit portion 121 is not contiguous with execution unit portion 122. By organizing the placement of these blocks in this manner, the physical length of signal interconnects that connect an execution unit portion with a corresponding register file portion can be reduced relative to other placement configurations, and thereby reducing the propagation delay of signals carried by the signal interconnects. Accordingly, the operating frequency of coprocessor 105 can be increased relative to other placement configurations.

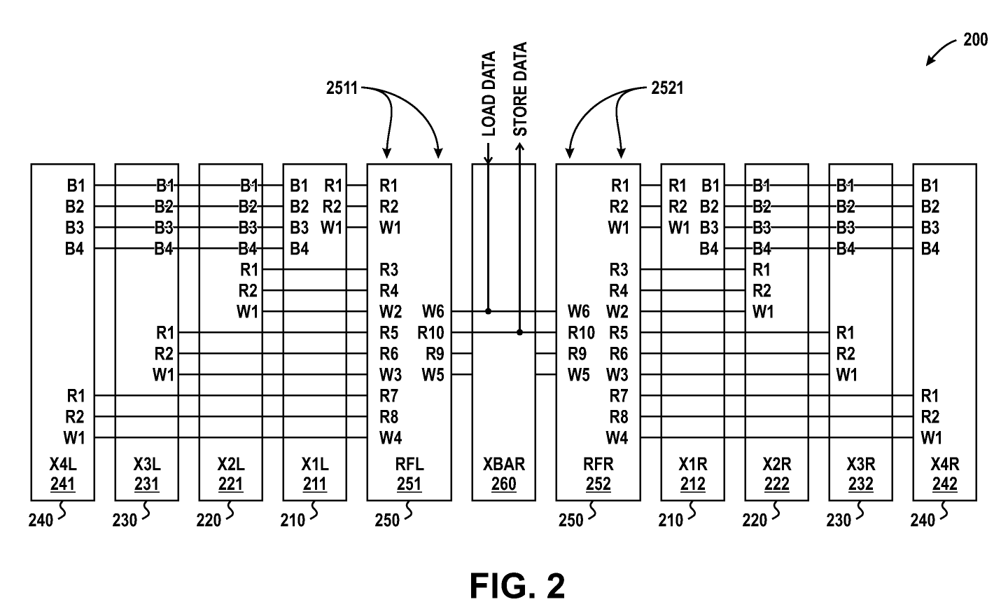

FIG. 2 is a block diagram illustrating a coprocessor 200 in accordance with a specific embodiment of the present disclosure. Coprocessor 200 can represent a more detailed implementation of coprocessor 105 of FIG. 1 and includes multiple execution units. Coprocessor 200 includes an execution unit 210 having a left portion X1L 211 and a right portion X1R 212, an execution unit 220 having a left portion X2L 221 and a right portion X2R 222, an execution unit 230 having a left portion X3L 231 and a right portion X3R 232, and an execution unit 240 having a left portion X4L 241 and a right portion X4R 242. Coprocessor 200 also includes a register file 250 having a left portion RFL 251 and a right portion RFR 252, and a cross-bar switch XBAR 260. Register file portion RFL 251 and register file portion RFR 252 each include a plurality of access ports 2511 and 2521, respectively.

A first portion of an instruction operand can be stored at a first portion of a register via a write access port labeled W6 at register file portion RFL 251, and a second portion of the instruction operand can be stored at a second portion of the register via a write port labeled W6 at register file portion RFR 252. An instruction operand to be stored at the combination of register file portion RFL 251 and register file portion RFR 252 can be received from a data cache, such as data cache 103 of FIG. 1 via a node labeled LOAD DATA, or the instruction operand can be received from an execution unit, such as execution unit 210 (the result of a preceding instruction execution). An instruction operand may include a single operational operand associated with a SISD instruction, or it may include multiple operational operands associated with a SIMD instruction. Register file portion RFL 251 and register file portion RFR 252 each include a read access port labeled R10 to retrieve data information from register file 250. For example, a first portion of a result of an instruction execution can be retrieved from a first portion of a register at register file portion RFL 251 via an access request at node labeled STORE DATA, and a second portion of that result can be retrieved from a corresponding second portion of the same register at register file portion RFR 252, via another access request at a node labeled STORE DATA. Data information retrieved from register file 250 can be stored at data cache 103 of FIG. 1. One skilled in the art will appreciate that control signals associated with the nodes labeled STORE DATA and LOAD DATA can be provided by various portions of the processor core 101, including control module 110. In addition, different interconnects associated with the nodes STORE DATA and LOAD DATA can be connected to register file portion RFL 251 and RFR 252.

Each portion of execution units 210, 220, 230, and 240 includes two read access ports and one write access port, which are connected to corresponding ports at an associated portion of register file 250. For example, execution unit X1L 211 has an input labeled R1 to request and receive a portion of an instruction operand from a port labeled R1 at register file portion RFL 251, an input labeled R2 to request and receive another portion of an instruction operand from a port labeled R2 at register file portion RFL 251, and an output labeled W1 to provide and store a result to a port labeled W1 at register file portion RFL 251. There is a one-to-one correspondence between access ports at execution unit portions X1L, X2L, X3L, and X4L and access ports at register file portion RFL 251, and a one-to-one correspondence between access ports at portions X1R, X2R, X3R, and X4R and access ports at register file portion RFR 252. Thus, portions of execution units on the left side can access register file portion RFL 251 and portions of execution units on the right side can access register file portion RFR 252.

Each portion of execution units 210, 220, 230, and 240 also includes four bypass ports, labeled B1, B2, B3, and B4, which are each operable to provide a portion of a result of one instruction execution to any of the other execution unit portions for use by a subsequent instruction execution. For example, portion X1L includes ports B1, B2, B3, and B4, and each port is connected to a corresponding port at execution unit portion X2L, X3L, and X4L. Thus, execution unit portion X1L can forward a result of an instruction execution directly to any of execution unit portions X2L, X3L, and X4L. If the bypass ports were not available, a result provided by one execution unit portion would have to be stored at the associated register file portion and subsequently retrieved by another execution unit portion that needs that result for use as an operand for another instruction execution. Thus, the bypass ports can increase the computational performance of coprocessor 200.

In an embodiment, an execution unit portion can include a greater or a fewer number of read ports, write ports, or bypass ports. For example, each portion of an execution unit operable to perform a multiply-addition operation, could include three read ports to receive three instruction operands that can respectively represent, for example, a multiplier, a multiplicand, and an addend, and one write port to provide a result of the operation. Coprocessor 200 also may include a greater or fewer number of execution units.

Cross bar switch 260 illustrated at FIG. 2 includes a read access port and a write access port connected to corresponding ports R9 and W5 at register file portion RFL 251, and a read access port and a write access port connected to corresponding ports R9 and W5 at register file portion RFR 252. For example, cross-bar switch 260 can transfer information (register data) stored at register file portion RFL 251 to register file portion RFR 252, from register file portion RFR 252 to register file portion RFL 251, from one register portion at register file portion RFL 251 to another register portion of register file portion RFL 251, or from a register portion at register file portion RFR 252 to another register portion at register file portion RFR 252. Thus, cross-bar switch 260 can relay data information between execution unit portions on the left-side and the right-side by transferring the information from one register file portion to another register file portion. In an embodiment, cross-bar switch 260 and register file portions RFL 251 and RFR 252 can include a greater number of ports so that cross-bar switch 260 can provide concurrent transfer of data information between register portions at register file portion RFL and register file portion RFR.

The operation of coprocessor 200 is similar to the operation of coprocessor 105 previously described with reference to FIG. 1, but coprocessor 200 is configured to execute up to four program instructions concurrently, using execution units 210, 220, 230, and 240, respectively. Each execution unit can be substantially equivalent and thereby operable to receive any program instructions interchangeably, or one or more of execution units 210-240 can be specialized to support a particular type of program instruction. For example, two of the four execution units can be configured to perform floating point operations, while the remaining two execution units can be configured to perform integer operations. Accordingly, the number of data bits manipulated by each execution unit can differ, and the number of bits of information stored at a register at register file 250 can be selected to accommodate the maximum size of an instruction operand received at a corresponding execution unit. The number of bits manipulated by an execution unit can be referred to as the width of the execution unit. Similarly, the number of bits stored at a register or a register portion can be referred to as the width of the register or register portion. For example, a register that includes 128 data bits has a width of 128 bits, and an execution unit that manipulates 64 bits of data information has a width of 64 bits.

In an embodiment, data information received from each of register file portion RFL 251 and from register file portion RFR 252 is represented by 64 bits of information, which together provide 128 bits of information that can be manipulated by a single program instruction. For example, an instruction operand of a SIMD instruction may reference a register that includes data information that represents eight 16-bit operational operands (data fields), four 32 bit operational operands, two 64 bit operational operands, and the like. A SISD program instruction may reference a register than includes data information stored at a register that represents a single 128-bit operational operand.

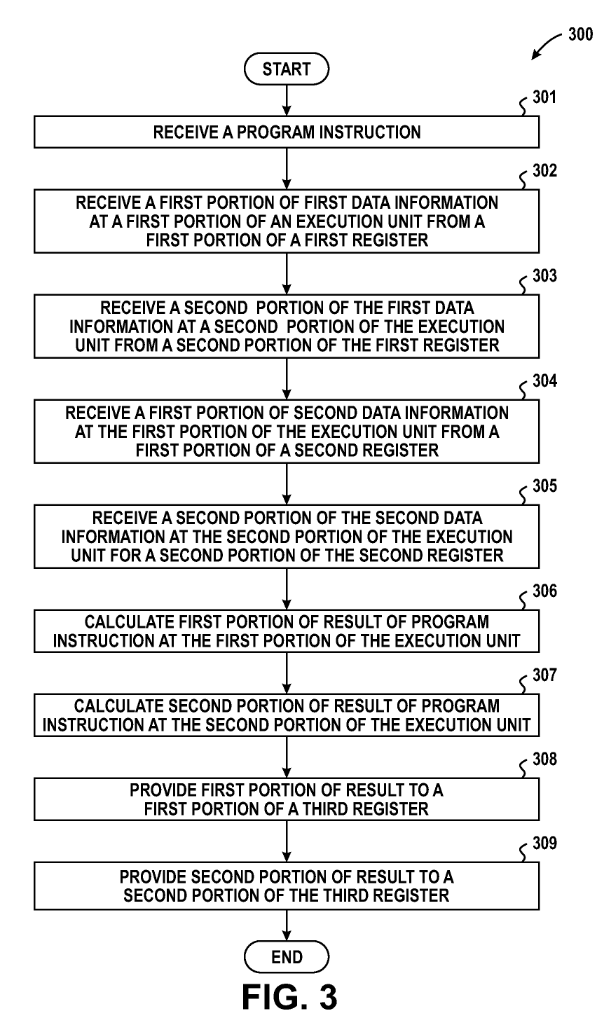

FIG. 3 is a block diagram flow diagram illustrating a method 300 for executing a program instruction at an execution unit, such as execution unit 210 of FIG. 2 in accordance with a specific embodiment of the present disclosure. Method 300 illustrates how each portion of an execution unit, such as execution unit portion X1L 211 and execution unit portion X1R 212 of FIG. 2, can together execute a single program instruction, such as a SIMD ADD instruction.

Method 300 begins at block 301 where a program instruction is received. For example, the program instruction can be provided to a data processor, such as coprocessor 200. The flow proceeds to block 302 where a first portion of an instruction operand, e.g., data information, is received at a first portion of an execution unit from a first portion of a first register. For example, execution unit portion X1L 211 of execution unit 210 can provide a set of control signals at a first access port of register file portion RFL 251 to retrieve a portion of the data information stored at a first register from a first portion of the register file. The data information from the first portion of the register file may include one or more individual sets of data, e.g., operational operands, to be operated upon independently by a SIMD instruction. The flow proceeds to block 303 where another portion of the data information stored at the first register is provided to a second portion of the execution unit from a second portion of register file. For example, execution unit portion X1R 212 of execution unit 210 can provide a set of control signals at a first access port of register file portion RFR 252 to retrieve a second portion of the data information stored at the first register from the second portion of the register file. The second portion of the data information also can include one or more sets of data.

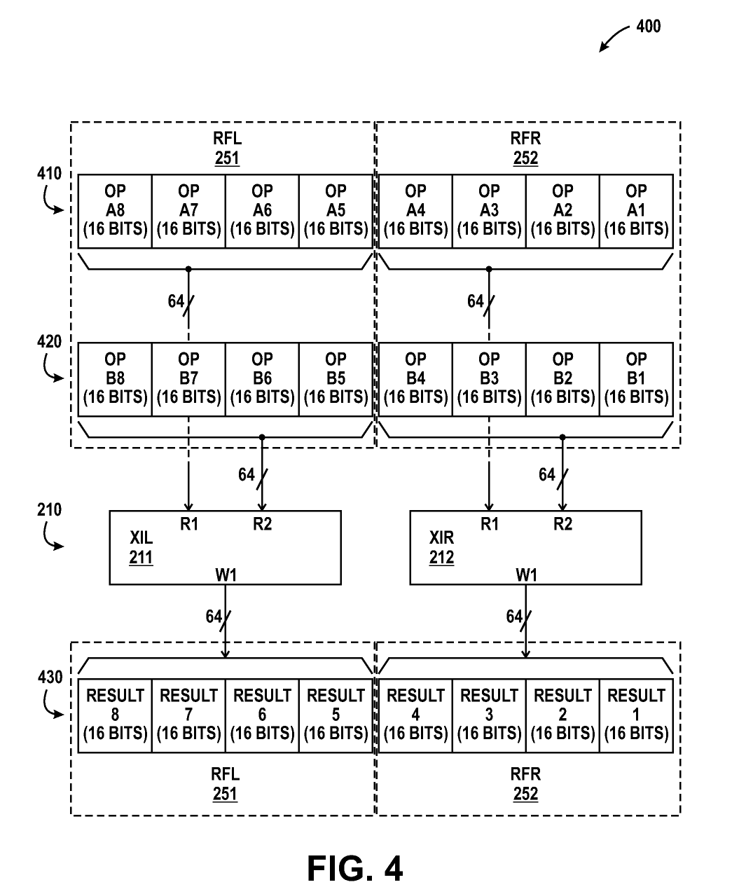

The flow proceeds to block 304 where data information from a first portion of a second register is received at the first portion of the execution unit. For example, execution unit portion X1L 211 can provide a set of control signals at a second access port of register file portion RFL 251 to retrieve a first portion of the second data information from a first portion of a second register. The flow proceeds to block 305 where data information from a second portion of the second registers is received at the second portion of the execution unit. For example, execution unit portion X1R 212 can provide a set of control signals at a second access port of register file portion RFR 252 to retrieve a second portion of the second data information from a second portion of the second register. Method 300 may be better understood with reference to FIG. 4.

FIG. 4 includes a block diagram 400 of a data flow corresponding to method 300 of FIG. 3 in accordance with a specific embodiment of the present disclosure. FIG. 4 illustrates a register 410, a register 420, a register 430, and an execution unit 210. Each register 410, register 420, and register 430 have a first portion included at register file portion RFL 251 and a second portion included at register file portion RFR 252. Execution unit 210 includes execution unit portion 211 and execution unit portion 212.

Register 410 contains an instruction operand that includes 128 bits of data information representing eight 16-bit sets of data, referred to as operational operands, labeled OP A1, OP A2, OP A3, OP A4, OP A5, OP A6, OP A7, and OP A8. Register 420 contains an instruction operand that includes 128 bits of data information representing eight 16-bit operational operands, labeled OP B1, OP B2, OP B3, OP B4, OP B5, OP B6, OP B7, and OP B8. Register 430 contains 128 bits of data information representing eight 16-bit results, labeled RESULT 1, RESULT 2, RESULT 3, RESULT 4, RESULT 5, RESULT 6, RESULT 7, and RESULT 8. Operational operands organized in this manner can also be referred to as packed operands, where the term operational operand refers to a set of input data information processed by a common operation. For example, a 128-bit instruction operand of a SIMD instruction can include eight 16-bit operational operands that are operated upon by 8 independent add operations.

Returning to FIG. 3, the flow proceeds to block 306 where a first portion of a result of the program instruction is calculated at the first portion of the execution unit, such as execution unit portion X1L 211. The flow proceeds to block 307 where a second portion of the result of the program instruction is calculated at the second portion of the execution unit, such as execution unit portion X1R 212. For example, again referring to FIG. 4, during execution of the program instruction at execution unit 210, eight individual arithmetic operations are performed based on eight respective pairs of operational operands. For example, if the arithmetic program instruction being executed is an ADD instruction, execution unit portion X1R 211 performs the operations:

OP A1+OP B1=RESULT 1 (Eq. 1)

OP A2+OP B2=RESULT 2 (Eq. 2)

OP A3+OP B3=RESULT 3 (Eq. 1)

OP A4+OP B4=RESULT 4 (Eq. 4)

Execution unit portion X1R 212 performs the operations:

OP A5+OP B5=RESULT 5 (Eq. 5)

OP A6+OP B6=RESULT 6 (Eq. 6)

OP A7+OP B7=RESULT 7 (Eq. 7)

OP A8+OP B8=RESULT 8 (Eq. 8)

The eight operations can be performed substantially simultaneously at execution unit 210. Returning once again to FIG. 3, the flow proceeds to block 308 where a first portion of a result of an instruction execution is stored at a first portion of a third register. For example, execution unit portion X1L 211 can provide a set of control signals at a third access port of register file portion RFL 251 to store a first portion of the result to a first portion of a third register. The flow proceeds to block 309 where a second portion of the result is provided to a second portion of the third register. For example, execution unit portion X2R 212 can provide a set of control signals at a third access port of register file portion RFR 252 to store a second portion of the result to a second portion of the third register. Returning to FIG. 4, the eight 16-bit results of the eight operations are stored at register 430, four results stored at register file portion RFL 251 and four results stored at register file portion RFR 252, and together can serve as an instruction operand of a subsequent program instruction. Note that the results of the operation can be forwarded directly to another execution unit for use as an instruction operand of a subsequent program instruction using one or more bypass ports illustrated at FIG. 2.

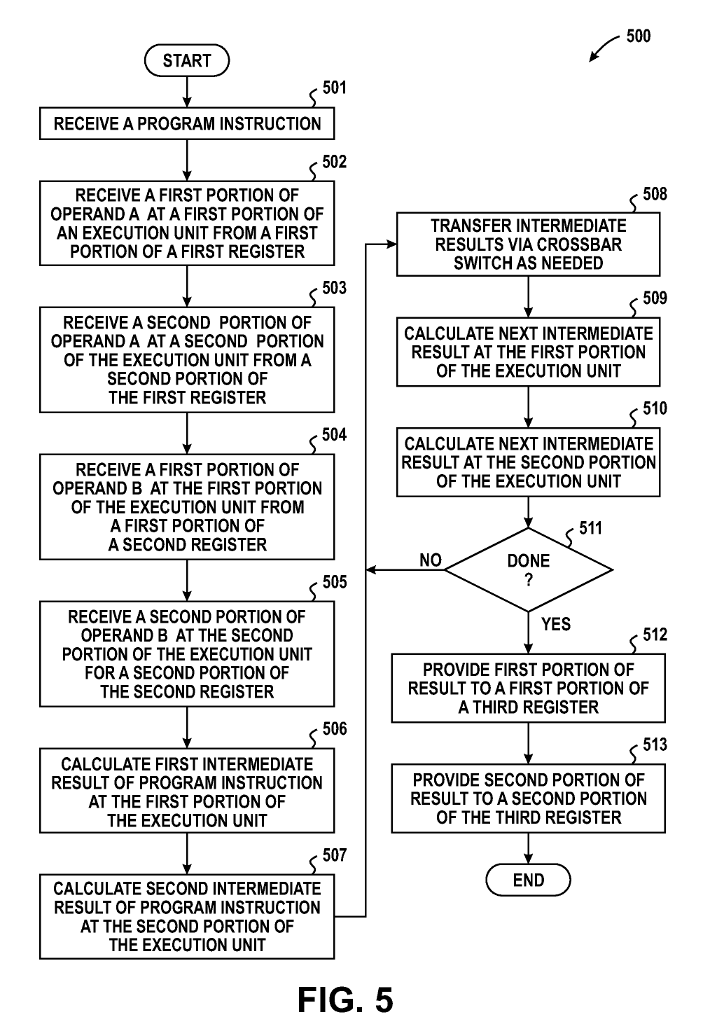

FIG. 5 is a flow diagram illustrating a method 500 for executing another program instruction at an execution unit, such as execution unit 210 of FIG. 2 in accordance with a specific embodiment of the present disclosure. Method 500 illustrates how each portion of an execution unit, such as execution unit portion X1L 211 and execution unit portion X1R 212 of FIG. 2, can execute a SISD instruction, such as an add instruction.

The flow begins at block 501 where a program instruction is received. For example, the program instruction can be provided to a data processor, such as coprocessor 200, by a CPU. The flow proceeds to block 502 where a first portion of instruction operand A is received at a first portion of an execution unit from a first portion of a first register. For example, execution unit portion X1L 211 can provide a set of control signals at a first access port at register file portion RFL 251 to retrieve a first portion of instruction operand A from a first portion of a first register. The flow proceeds to block 503 where a second portion of instruction operand A is received at a second portion of the execution unit from a second portion of the first register. For example, execution unit portion X1R 212 can provide a set of control signals at a first access port at register file portion RFR 252 to retrieve a second portion of instruction operand A from a second portion of the first register. The flow proceeds to block 504 where a first portion of instruction operand B is received from a first portion of an execution unit from a first portion of a second register. For example, execution unit portion X1L 211 can provide a set of control signals at a second access port at register file portion RFL 251 to retrieve a first portion of instruction operand B from a first portion of a second register. The flow proceeds to block 505 where a second portion of instruction operand B is received at a second portion of the execution unit from a second portion of the second register. For example, execution unit portion X1R 212 can provide a set of control signals at a second access port at register file portion RFR 252 to retrieve a second portion of instruction operand B from a second portion of the second register.

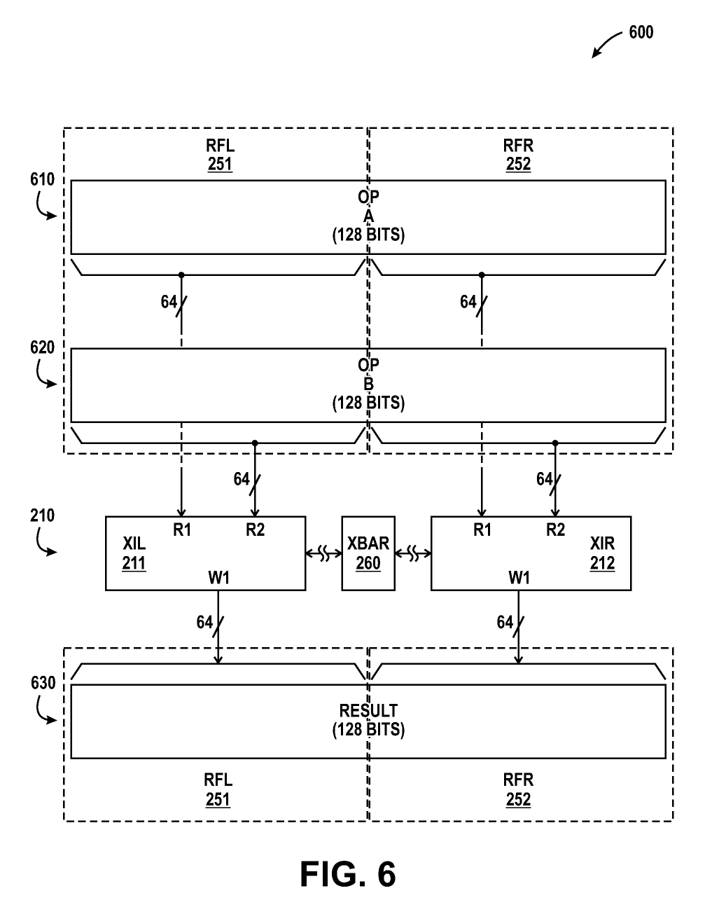

Method 500 may be better understood with reference to FIG. 6. FIG. 6 includes a block diagram 600 illustrating method 500 of FIG. 5 in accordance with a specific embodiment of the present disclosure. FIG. 6 includes a register 610 including a first portion included at register file portion RFL 251 and a second portion included at register file portion RFR 252, a register 620 including a first portion included at register file portion RFL 251 and a second portion included at register file portion RFR 252, execution unit 210 including execution unit portion 211 and execution unit portion 212, and a third register 630 including a first portion included at register file portion RFL 251 and a second portion included at register file portion RFR 252, and cross-bar switch 260.

Register 610 includes 128 bits of data information representing a single operational operand of the same size as the instruction operand labeled OP A. Register 620 includes 128 bits of data information representing a single operational operand of the same size as the instruction operand labeled OP B. Register 630 includes 128 bits of data information representing a single result labeled RESULT.

Returning to FIG. 5, the flow proceeds to block 506 where a first portion of a first intermediate result of the program instruction is calculated at the first portion of the execution unit, such as execution unit portion X1L 211. The flow proceeds to block 507 where a second portion of the intermediate result of the program instruction is calculated at the second portion of the execution unit, such as execution unit portion X1R 212. Once again referring to FIG. 6, execution unit 210 performs a single 128-bit operation based on operational operand OP A and operational operand OP B. For example, if the arithmetic program instruction being executed is an ADD instruction, execution unit 210 performs the operations:

OP A+OP B=RESULT (Eq. 9)

Where execution unit portion 212 operates on the least significant portion of the calculation and execution unit portion 211 operates on the most significant portion of the calculation.

Because execution unit portion 211 and execution unit portion 212 are not directly interconnected to provide a contiguous 128-bit wide data path, the execution of the program instruction may require iterative calculations at each portion of execution unit 210 to complete execution of the program instruction. Returning to FIG. 5, having calculated the first intermediate result at each portion of the execution unit, the flow proceeds to block 508 where portions of the intermediate results are transferred between portions of the execution unit 210 via a cross-bar switch, as needed. For example, a portion of an intermediate result, such as a carry-out, can be transferred from execution unit portion 211 to execution unit portion 212 by first storing the portion of the intermediate result at a register portion at register file portion 251. Cross-bar switch 260 can retrieve the portion of the intermediate result from register file portion 251 and store it at a register portion at register file portion 252, where it can be retrieved by execution unit portion 212. The flow proceeds to block 509 where a first portion of the next intermediate result is calculated at the first portion of the execution unit, such as execution unit portion 211. The flow proceeds to block 510 where a second portion of the next intermediate result is calculated at the second portion of the execution unit, such as execution unit portion 212. Furthermore, additional data manipulation can be performed at cross-bar switch 260 while the portions of the intermediate results are being transferred. For example, cross-bar switch 260 can perform a left-shift operation, a right-shift operation, masking of a portion of an intermediate result, data alignment operations, and the like.

The flow proceeds to decision block 511 where a control module, such as control module 110 of FIG. 1, determines whether execution of the program instruction is complete. If execution is not complete and further iterations are indicated, the flow returns to block 508 where portions of the current intermediate result can be transferred between portions of the execution unit via the cross-bar switch. If execution of the program instruction is complete, the flow proceeds to block 512 where the most-significant portion of the final result of the operation is stored at a first portion of a third register at the first register file portion, such as register file portion RFL 251. The flow proceeds to block 513 where a least-significant portion of the final result of the operation is stored at a second portion of the third register at the second register file portion, such as register file portion RFR 252. The third register containing the result of the operation corresponds to register 630 of FIG. 6. The final result stored at register 130 can serve as an instruction operand to a subsequent program instruction. As previously described, control module 110 can include a micro-sequencer device operable to execute micro-code instructions stored at a micro-code memory device. The micro-sequencer device, in addition to other logic modules included at control module 110, can configure cross-bar switch 260 and execution unit 210 to perform the previously described iterative calculations suitable to complete the operation specified by the arithmetic program instruction.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed.

Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

For example, coprocessor 105 and coprocessor 200 include two portions of each execution unit, each execution unit portion associated with one of two register file portions. In an embodiment, an execution unit can be partitioned into another number of portions, such as four, and the register file can be portioned into a like number of portions, wherein each execution unit portion is coupled to a corresponding register file portion. In another embodiment, an execution unit can be configured to execute two program instructions substantially simultaneously. For example, execution unit portion 121 can execute one program instruction while execution unit portion 122 concurrently executes a second program instruction. In another embodiment, the register file can be a contiguous register file having a first set of access ports that can only access least-significant bits of registers of the register file, and a second set of access ports that can only access the remaining most-significant bits of registers of the register file.

It will be appreciated that whereas execution unit portion 121 is coupled to register file portion 131 via corresponding access ports, execution unit portion 121 is decoupled from register file portion 132 in that execution unit portion 121 cannot access a portion of a register's data at register file portion 132 without first transferring the information from register file portion 132 to register file portion 131 using cross-bar switch 140. Similarly, execution unit portion 122 is coupled to register file portion 132 and decoupled from register file portion 131, and therefore, execution unit portion 122 can not access a portion of a register's data at register file portion 131.

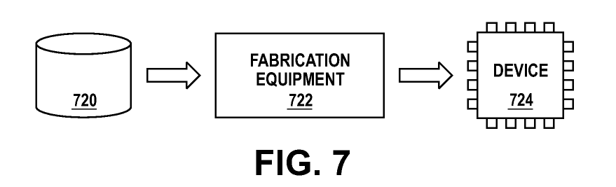

It will be appreciated that various aspects of the present disclosure can be implemented in both hardware and software. For example, in one embodiment a computer usable (e.g., readable) memory is configured to store instructions, e.g., program instruction or microcode instructions, (a computer readable program code) that can implement various aspects of the present disclosure including the following embodiments: (i) configuration of a data processor to implement the functions disclosed herein, such as methods that configure a data processor to access instruction operands as disclosed herein; (ii) the fabrication of the devices disclosed herein as described further below with reference to FIG. 7, such as devices that access the instruction operands as disclosed herein; and (iii) a combination of the methods and fabrication of the devices and methods disclosed herein.

FIG. 7 illustrates use of a computer readable memory in the fabrication of a device as disclosed herein. A computer readable memory 720, such as a semiconductor, magnetic disk, optical disk, optical, or analog-based medium, stores Hardware Description Language (HDL) instructions. The HDL instructions can include, but are not limited to, Verilog or another hardware representation for implementing various aspects disclosed herein. The HDL instructions can be used to configure various processes and equipment 722 used to manufacture a device 724. The device 724 may be an integrated circuit fabricated using fabrication equipment, such as the type of equipment found in mask fabrication and semiconductor fabrication facilities, for example.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

What is claimed is:

1. A method of accessing an instruction operand for a program instruction by an execution unit comprising:
accessing a first portion of the instruction operand from a first register of a register file responsive to a first access request from a first portion of the execution unit to a first access port of the register file; and
accessing a second portion of the instruction operand from the first register responsive to a second access request from a second portion of the execution unit to a second access port of the register file.

2. The method of claim 1, wherein the program instruction is a single-instruction multiple-data (SIMD) instruction, and the instruction operand includes multiple data to be operated upon by an arithmetic operation associated with the SIMD instruction.

3. The method of claim 2 further comprising:
concurrently executing the arithmetic operation associated with the SIMD instruction at the first portion of the execution unit using the first portion of the instruction operand and at the second portion of the execution unit using the second portion of the instruction operand.

4. The method of claim 1, wherein the first portion of the instruction operand is not accessible via the second access port, and the second portion of the instruction operand is not accessible via the first access port.

5. The method of claim 1, wherein the first access port is one of a first plurality of access ports that can access first portions of a plurality of registers of the register file, including a first portion of the first register storing the first portion of the instruction operand, but not access second portions of the plurality of registers, including a second portion of the first register storing the second portion of the instruction operand, and the second access port is one of a second plurality of access ports that can access the second portions of the plurality of registers, but not access the first portions of the plurality of registers.

6. The method of claim 1, wherein the program instruction is a single-instruction single-data (SISD) instruction.

7. The method of claim 6 further comprising:
storing a first portion of an intermediate result of the SISD instruction, determined by the first portion of the execution unit, at a first portion of a second register of the register file via the first access port; and
transferring the intermediate result from the first portion of the register to a second portion of one of the registers of the register file to facilitate access of the intermediate result by the second portion of the execution unit to complete execution of the SISD instruction.

8. The method of claim 7, wherein transferring the intermediate result further includes loading the intermediate result via a third access port of the register file, and storing the intermediate result via a fourth access port of the register file, wherein the first portion of the register is not accessible via the fourth access port and the second portion of the register is not accessible via the third access port.

9. The method of claim 8, wherein transferring the intermediate result further includes configuring a transfer module to transfer the intermediate result.

10. The method of claim 9, wherein a location of the transfer module is physically located between the third access port and the fourth access port.

11. The method of claim 1, wherein a location of the register file is physically located between the first portion of the execution unit and the second portion of the execution unit.

12. A device comprising:
a register file including:
a plurality of registers, each register including a first portion and a second portion;
a first access port coupled to a first portion of the plurality of registers to access the first portion of registers of the plurality of registers in response to a first access request, the first access port not coupled to access the second portion of the registers;
a second access port coupled to the second portion of the plurality of registers to access the second portion of registers of the plurality of registers in response to a second access request, the second access port not coupled to access the first portion of the registers; and
an execution unit to execute program instructions, the execution unit including:
a first portion including an access port coupled to the first access port of the register file to access a first portion of an instruction operand from a register of the plurality of registers; and
a second portion including an access port coupled to the second access port of the register file to access a second portion of the instruction operand from the register.

13. The device of claim 12, wherein the execution unit is to execute a single-instruction multiple-data (SIMD) instruction of the program instructions.

14. The device of claim 13, wherein the execution unit is to execute a single-instruction single-data (SISD) instruction of the program instructions.

15. The method of claim 12, a location of the register file is disposed between a location of the first access port of the execution unit and a location of the second access port of the execution unit.

16. The device of claim 12 wherein the first access port of the register file is one of a first plurality of access ports of the register file coupled to access the first portion of the registers but not coupled to access the second portion of the registers, and the second access port of the register file is one of a second plurality of access ports of the register file coupled to access the second portion of the registers but not coupled to access the first portion of the registers, the device further comprising:
a transfer module coupled to a third access port that includes one of the first plurality of access ports, and to a fourth access port that is one of the second plurality of access ports, the transfer module to transfer information from a first portion of a first register of the plurality of registers to a second portion of a second register of the plurality of registers via the third access port and the fourth access port.

17. The method of claim 12, a location of the transfer module file is disposed between a first location of the register file and a second location of the register file.

18. A computer readable memory storing data representative of a set of program instructions that, when executed, are adapted to configure a data processor to access a first portion of an instruction operand from a register file responsive to a first access request from a first portion of an execution unit, and to access a second portion of the instruction operand from the register file responsive to a second access request from a second portion of an execution unit.

19. The computer readable memory of claim 18, wherein the set of program instructions are Hardware Description Language instructions that configure the data processor by adapting a manufacturing process to facilitate formation of the data processor.

20. The computer readable memory of claim 18, wherein the set of program instructions include single-instruction multiple-data instructions (SIMD).
